(19) United States
(12) Patent Application Publication
(10) Pub. No.: US 2015/0212594 A1
(43) Pub. Date: Jul. 30, 2015

(54) TOUCHPAD INPUT DEVICE AND TOUCHPAD CONTROL PROGRAM

(71) Applicant: ALPS ELECTRIC CO., LTD., Tokyo (JP)

(72) Inventor: Kazuhito Oshita, Miyagi-ken (JP)

(21) Appl. No.: 14/602,920

(22) Filed: Jan. 22, 2015

(30) Foreign Application Priority Data
Jan. 27, 2014 (JP) 2014-011974

(51) Int. Cl. G06F 3/038; G06F 3/0354

(52) U.S. Cl. CPC G06F 3/038; G06F 3/03547; G06F 2203/0338

(57) ABSTRACT

A control unit configured to recognize a touch operation on an operating screen by an object, based on a contact position of the object detected based on electric variance output according to a proximity state of the object as to the operating face, and validate or invalidate the touch operation based on a keyboard operation state. When there has been a touch operation during keyboard operations or within a predetermined amount of time after keyboard operations, the control unit sets a region where there has been a touch operation to a touch operation invalid region, and sets a region where there has been no touch operation to a touch operation valid region.

### CLAIM OF PRIORITY

This application claims benefit of priority to Japanese Patent Application No. 2014-011974 filed on Jan. 27, 2014, which is hereby incorporated by reference in its entirety.

### BACKGROUND

1. Field of the Disclosure

The present disclosure relates to a touchpad input device installed in a laptop personal computer (PC) or the like, and to a touchpad control program.

2. Description of the Related Art

Touchpad input devices provided to laptop PCs and so forth have tended to become larger in size in recent years. The palm of the hand thus more readily comes into contact with the touchpad input device when operating the keyboard, resulting in erroneous operation. Accordingly, an erroneous operation prevention function is being considered, to prevent such erroneous operations, which invalidates touchpad operations during keyboard operations or for a certain amount of time thereafter.

Japanese Unexamined Patent Application Publication 10-78850 discloses an erroneous operation prevention function, which invalidates touchpad operations during keyboard operations and for a certain amount of time after having operated the keyboard. While this can prevent erroneous operation by the palm, it also means that normal operations by the fingertips are not accepted either, immediately after operating the keyboard. This has been a problem in that normal operations by the fingertips are impeded.

### SUMMARY

A touchpad input device includes a control unit configured to recognize a touch operation on an operating screen by an object, based on a contact position of the object detected based on electric variance output according to a proximity state of the object as to the operating face, and validate or invalidate the touch operation based on a keyboard operation state. When there has been a touch operation during keyboard operations or within a predetermined amount of time after keyboard operations, the control unit sets a region where there has been a touch operation to a touch operation invalid region, and sets a region where there has been no touch operation to a touch operation valid region.

A contact position of a palm during keyboard operations and after keyboard operations generally is on both ends of the operating screen and do not move much, so erroneous operations by the palms can be prevented by setting these regions as touch operation invalid regions. On the other hand, the position of a fingertip when performing normal operations is generally around the middle of the operating screen, so by setting a region where there has been no touch operation as the touch operation valid region, normal operations by the fingertips are less readily impeded.

According to a second aspect, a touchpad control program stored in a non transitory memory is configured to recognize a touch operation on an operating screen by an object, based on a contact position of the object detected based on electric variance output according to a proximity state of the object as to the operating face, and validate or invalidate the touch operation based on a keyboard operation state. In a case where there has been a touch operation during keyboard operations or within a predetermined amount of time after keyboard operations, a region where there has been a touch operation is set to a touch operation invalid region, and a region where there has been no touch operation is set to a touch operation valid region.

### BRIEF DESCRIPTION OF THE DRAWINGS

FIG. 1 is a diagram illustrating a touchpad and keyboard installed in a laptop personal computer according to an embodiment;

FIG. 2 is a system configuration diagram of the touchpad input device and keyboard according to the embodiment;

FIG. 3 is a flowchart for a control unit according to the embodiment;

FIG. 4 is an explanatory diagram for step S2;

FIG. 5 is an explanatory diagram for step S10; and

FIG. 6 is a diagram illustrating a modification.

### DESCRIPTION OF THE EXEMPLARY EMBODIMENTS

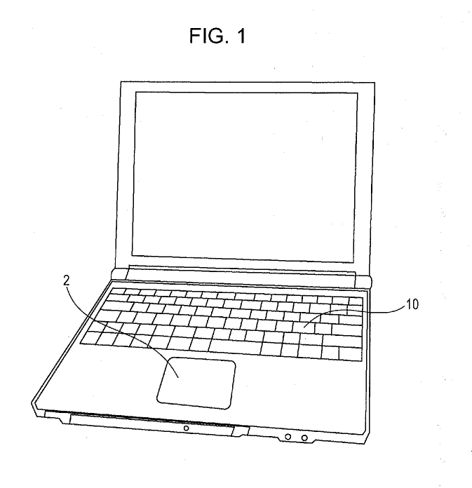

A touchpad input device 1 according to the present embodiment will be described with reference to FIGS. 1 through 5. FIG. 1 is a diagram illustrating a touchpad 2 and keyboard 10 installed in a laptop personal computer (PC) according to the present embodiment. The touchpad 2 is attached at the middle of a palm rest portion, on the near side of the keyboard 10. The touchpad 2 is a component making up the touchpad input device 1, and is configured including a printed circuit board, electrodes laid upon the printed circuit board, a surface sheet applied on the upper side of the electrodes, and so forth.

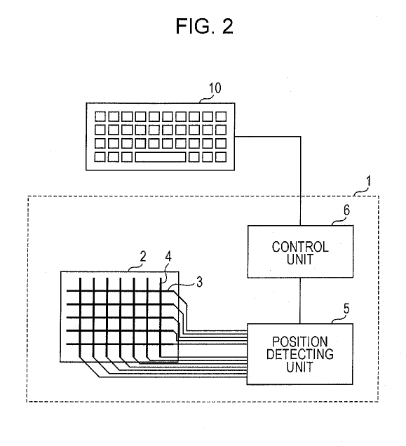

FIG. 2 is a system configuration diagram of the touchpad input device 1 and the keyboard 10. The touchpad input device 1 is configured including the touchpad 2, a position detecting unit 5 made up of an application-specific integrated circuit (ASIC) or the like connected to the touchpad 2 via multiple wires, and a control unit 6 connected to the position detecting unit 5. The touchpad 2 is configured including the printed circuit board, multiple detecting electrodes 3 laid on the printed circuit board extending in the horizontal direction, multiple detecting electrodes 4 laid above the detecting electrodes 3 extending in the vertical direction, with an insulating layer interposed therebetween, and a surface sheet applied on the upper side of the detecting electrodes 4. The upper face of the surface sheet serves as the operating face. Based on the voltage application state to the detecting electrodes 4 and the voltage detection state of the detecting electrodes 3, the position detecting unit 5 detects change in capacitance between the electrodes and thereby detects a contact position of a finger or the like, generates position signals thereof, and transmits the position signals to the control unit 6. The control unit 6 corresponds to a computing device and storage device of the laptop PC, and receives position signals from the position detecting unit 5 to recognize touch operations being made on the operating face. The control unit 6 stores control programs according to the present embodiment, and executes control operations according to the present embodiment.

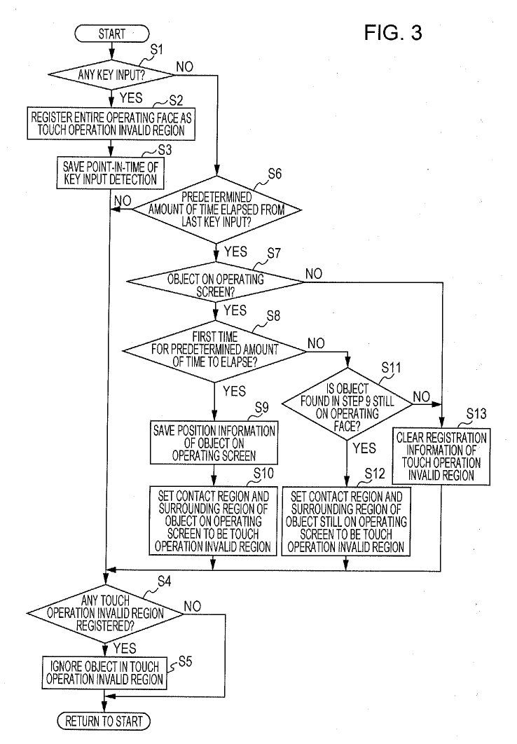

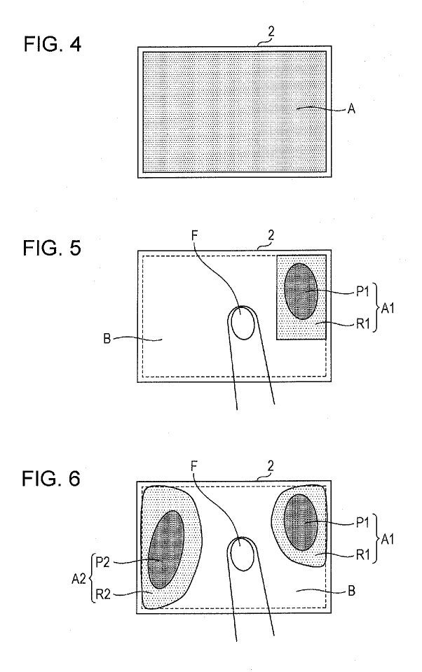

FIG. 3 is a flowchart illustrating the control operations of the control unit 6 according to the present embodiment. FIG. 4 is a diagram for describing a touch operation invalid region set in step S2 in the flowchart in FIG. 3. FIG. 5 is a diagram for describing a touch operation invalid region set in step S10 in the flowchart in FIG. 3. The operations of the touchpad input device 1 according to the present embodiment will be described with reference to FIGS. 3 through 5.

First, in step S1, determination is made regarding whether or not there has been a key input. In a case where determination is made that there has been a key input, the flow advances to step S2.

In step S2, the entire operating face is registered as a touch operation invalid region A, as illustrated in FIG. 4.

In step S3, the point-in-time of the key input is saved.

In step S4, determination is made regarding whether or not there is registration of a touch operation invalid region. In a case where there is registration of a touch operation invalid region, the flow advances to step S5.

In step S5, any object in the touch operation invalid region is ignored, and the flow returns to the start. By performing the processing of step S1 through step S5, even if the palm accidentally comes into contact with the touchpad 2 while inputting using the keys, the touchpad input device 1 can be prevented from making unintended operations due to the contact by the palm.

In a case where determination is made in step S1 that there is no key input, the flow advances to step S6.

In step S6, determination is made regarding whether or not a predetermined amount of time has elapsed from the last key input. In a case where determination is made that the predetermined amount of time has not elapsed, the flow advances to step S4. By providing this step, erroneous operation can be prevented not only during key input but also for a certain amount of time after key input has ended.

In a case where determination is made in step S6 that the predetermined amount of time has elapsed, the flow advances to step S7.

In step S7, determination is made regarding whether or not there is an object on the operating face. In a case where determination is made that there is an object on the operating face, the flow advances to step S8.

In step S8, determination is made regarding whether or not this is the first time for the predetermined time to elapse. In a case where determination is made that this is the first time for the predetermined time to elapse, the flow advances to step S9.

In step S9, the position information of the object on the operating screen is saved, and the flow advances to step S10.

In step S10, a contact region P1 of the object such as a palm or the like on the operating face, and a peripheral region R1 thereof, are set as a touch operation invalid region A1, as illustrated in FIG. 5, and the flow advances to step S4. Other regions are not set to be touch operation invalid regions, and are set to be a touch operation valid region B. This step S10 is a feature operation of the present invention. Note that while the peripheral region R1 is rectangular in FIG. 5, this is not restrictive, and a shape such as the contact region P1 having been enlarged may be set, for example, such as illustrated in FIG. 6. Also, while only one contact region of an object such as a palm or the like is illustrated in FIG. 5, if there are multiple as illustrated in FIG. 6 the same processing may be performed for each.

A contact position of a palm during keyboard operations and after keyboard operations generally is on both ends of the operating screen and do not move much, so erroneous operations by the palms can be prevented by setting these regions as touch operation invalid regions A1 and A2, as illustrated in FIG. 5. On the other hand, the contact position of a fingertip F when performing normal operations is generally around the middle of the operating screen, so by setting a region where there has been no touch operation as the touch operation valid region B, normal operations by the fingertips are less readily impeded.

In a case where determination is made in step S8 that this is not the first time for the predetermined time to elapse, the flow advances to step S11.

In step S11, determination is made regarding whether or not the object found in step S9 is still on the operating face. In a case where the object found in step S9 is still on the operating face, the flow advances to step S12.

In step S12, the contact region and peripheral region of the object still on the operating face is set as a touch operation invalid region, and the flow advances to step S4. By performing the operations of step S11 and step S12, the region where there has been a touch operation and the peripheral region thereof may be maintained as a touch operation invalid region if the touch operation is continued, thereby preventing erroneous operations by the palm.

In a case where the object found in step S9 is not on the operating face in step S11, the flow advances to step S13.

In step S13, the registration information of the touch operation invalid region is cleared, and the flow advances to step S4. By performing the operations of step S11 and step S13, the region where there has been a touch operation and the peripheral region thereof may be set to a touch operation valid region if the touch operation is not continued. This sets the entire face to the touch operation valid region, and normal operations by the fingertips are not impeded.

Thus, the touchpad input device 1 according to the present embodiment includes a control unit 6 which recognizes touch operations as to the operating face based on the contact position of an object detected based on electrical variance output according to the proximity state of the object as to the operating face, and validates or invalidates touch operations based on the keyboard operating state. In a case where there has been a touch operation during keyboard operations or within a predetermined amount of time after keyboard operations, the control unit 6 sets regions F1 and F2 where touch operations were performed, and peripheral regions R1 and R2, to touch operation invalid regions A1 and A2. On the other hand, regions where not touch operations were performed are set to a touch operation valid region B.

According to this arrangements, the contact positions of palms while operating the keyboard or after operating the keyboard generally are on both ends of the operating screen and do not move much, so by setting these regions as touch operation invalid regions A1 and A2, erroneous operations by the palms can be prevented. On the other hand, the contact position of a fingertip F when performing normal operations is generally around the middle of the operating screen, so by setting a region where there has been no touch operation as the touch operation valid region B, normal operations by the fingertips are less readily impeded.

Also, the touchpad input device 1 according to the present embodiment may have a feature that the control unit 6 sets the region where there has been a touch operation and the peripheral region thereof to a touch operation invalid region if the touch operation is being continued, and sets the region where there has been a touch operation and the peripheral region thereof to a touch operation valid region if the touch operation is not continued.

Accordingly, once the palm has left contact, the region where the palm was in contact also becomes a touch operation valid region. Accordingly, normal operations by the fingertips are not impeded.

Note that the present invention is not restricted to the above-described embodiment, and that various modifications may be made without departing from the essence of the present invention. While the region where an object has touched and the peripheral region thereof is set to a touch operation invalid region in the present embodiment, the present invention is not restricted thusly, and an arrangement may be made where the contact region of an object and predetermined regions fixedly set to both sides of the touchpad 2 are operation invalid regions. Also, an arrangement may be made where, if determination can be made that the object, which has made contact is not a palm but a finger, a touch operation invalid region may not be set.

What is claimed is:

1. A touchpad input device comprising:
a control unit configured to recognize a touch operation on an operating screen by an object, based on a contact position of the object detected based on electric variance output according to a proximity state of the object as to the operating face, and validate or invalidate the touch operation based on a keyboard operation state;
wherein, when there has been a touch operation during keyboard operations or within a predetermined amount of time after keyboard operations, the control unit sets a region where there has been a touch operation to a touch operation invalid region, and sets a region where there has been no touch operation to a touch operation valid region.

2. The touchpad input device according to claim 1,
wherein the control unit sets the region where there has been a touch operation to a touch operation invalid region if the touch operation is being continued, and sets the region where there has been a touch operation to a touch operation valid region if the touch operation is not continued.

3. A non-transitory readable memory having stored therein a touchpad control program, the program configured to recognize a touch operation on an operating screen by an object, based on a contact position of the object detected based on electric variance output according to a proximity state of the object as to the operating face, and validate or invalidate the touch operation based on a keyboard operation state;
wherein, when there has been a touch operation during keyboard operations or within a predetermined amount of time after keyboard operations, a region where there has been a touch operation is set to a touch operation invalid region, and a region where there has been no touch operation is set to a touch operation valid region.

4. The touchpad control program according to claim 3,
wherein the region where there has been a touch operation is continuously set to a touch operation invalid region if the touch operation is being continued, and the region where there has been a touch operation is set to a touch operation valid region if the touch operation is not continued.
